(19) United States
(12) Patent Application Publication
(10) Pub. No.: US 2015/0310541 A1
(43) Pub. Date: Oct. 29, 2015

(54) VIRTUAL CONCIERGE SERVICE

(71) Applicant: PLUSMORE NEW YORK LLC, NEW YORK, NY (US)

(72) Inventors: EREN PAMIR, NEW YORK, NY (US); ADIS GUTIC, NEW YORK, NY (US); STEVE SAIEH, MIAMI, FL (US); PATRICK SCOTT, NEW YORK, NY (US); KRISH SHYAM JAGIRDAR, NEW YORK, NY (US); EMANUEL SASANIAN, NEW YORK, NY (US)

(73) Assignee: PLUSMORE NEW YORK LLC, NEW YORK, NY (US)

(21) Appl. No.: 14/259,660

(22) Filed: Apr. 23, 2014

(51) Int. Cl. G06Q 30/06; G06Q 30/02; H04L 29/06; G06F 3/0484

(52) U.S. Cl. CPC G06Q 30/0643; G06F 3/04842; G06Q 30/0275; G06Q 30/0269; H04L 63/08

(57) ABSTRACT

Technologies are generally described for systems, devices and methods effective to generate data associated with a rented room. The methods may include receiving authentication credentials related to a profile at a computing device. The methods may further include identifying information related to the profile. The methods may further include displaying, on the computing device, images of goods or services based on the information. The methods may further include receiving a selection of at least one of the goods or services at the computing device. The methods may include generating data to be added to a document relating to the rented room, the data effective to identify the selected goods and/or services. The methods may further include recommending a service, based on the information. The methods may further include sending an advertisement to the computing device, based on the profile.

### BACKGROUND

Unless otherwise indicated herein, the materials described in this section are not prior art to the claims in this application and are not admitted to be prior art by inclusion in this section.

Hotel patrons may be offered one or more services and/or products from a hotel during a stay. In some examples, a hotel may offer transportation services, foods, beverages, and/or reservations to local restaurants and events. Patrons of a hotel may be unfamiliar with the city or area in which the hotel is located. The hotel or hotel staff may make suggestions to the hotel patron based upon the hotel patron's interests.

### SUMMARY

In some examples, methods to generate data associated with a rented room are generally described. The methods may include receiving authentication credentials related to a profile at a computing device. In various examples, the computing device may be included with the rented room. In some other examples, the methods may include identifying information related to the profile. The methods may further include displaying, on the computing device, images of goods or services based on the information. In other examples, the methods may further include receiving a selection of at least one of the goods or services at the computing device. In still other examples, the methods may include generating data to be added to a document relating to the rented room, the data effective to identify the selected goods and/or services.

In some other examples, methods for recommending a first service at a computing device based on the selection of a second service are generally described. In some examples, the methods may include receiving authentication credentials related to a profile at a computing device. The methods may further include identifying information related to the profile. In other examples, the methods may include displaying, on the computing device, images of one or more services based on the information. In some other examples, the methods may further include receiving a selection of the second service from among the images of the one or more services at the computing device. In various other examples, the methods may include recommending the first service at the computing device, based on the selection of the second service.

In various other examples, methods for providing an advertisement to a device are generally described. The methods may include receiving a request from a device inside a structure. In some other examples, the methods may further include identifying a device profile of the device. In various examples, the methods may further include identifying a structure profile of the structure. In some examples, the structure profile may be different from the device profile. In still other examples, the methods may further include identifying a user profile of a user in association with the device. The methods may further include identifying an advertisement based on the user profile and the structure profile. In other examples, the methods may include sending the advertisement to the device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to implement a virtual concierge service;

FIG. 2 illustrates another system that can be utilized to implement a virtual concierge service to multiple users;

FIG. 3 depicts a flow diagram for an example process to generate data associated with a rented room;

FIG. 4 depicts a flow diagram for an example process for recommending a service at a computing device;

FIG. 5 depicts a flow diagram for an example process for implementing a virtual concierge service;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems and devices, related to a virtual concierge service.

Briefly stated, technologies are generally described for systems, devices and methods effective to generate data associated with a rented room. The methods may include receiving authentication credentials related to a profile at a computing device. The computing device may be included with the rented room. The methods may include identifying information related to the profile. The methods may further include displaying, on the computing device, images of goods or services based on the information. The methods may further include receiving a selection of at least one of the goods or services at the computing device. The methods may include generating data to be added to a document relating to the rented room, the data effective to identify the selected goods and/or services.

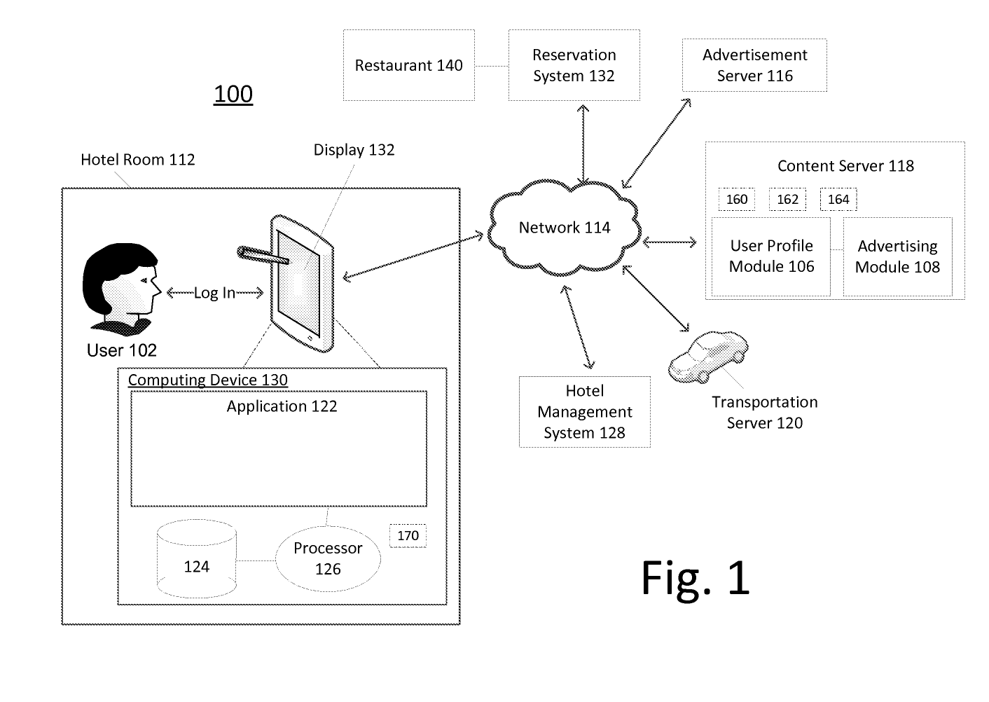

FIG. 1 illustrates an example system 100 that can be utilized to implement a virtual concierge service, arranged in accordance with at least some embodiments described herein. In some examples, system 100 may include a computing device 130 and a content server 118. Computing device 130 may be provided together with a rented room by a hotelier or as part of a hotel service. For example, a user 102 may rent a hotel room 112. In some examples, hotel room 112 may be a room in a hotel, lodge, inn, motel or other structure with rentable rooms. Computing device 130 may be provided as an amenity to user 102 which may be included in the price of hotel room 112. In another example, computing device 130 may be included as a paid service. In some examples, computing device 130 may be a tablet computer, a desktop terminal, a smart television, and/or another computing device. Computing device 130 may include a display 132, a memory 124, and/or a processor 126. Processor 126 may be configured to be in communication with memory 124. Computing device 130 may be located inside hotel room 112. Computing device 130 may have a device profile 170 that may be a profile associated with computing device 130. In an example, device profile 170 may be configured to identify computing device 130.

User 102 may perform a log in to gain access to a user profile 160 associated with user 102. For example, user 102 may provide authentication credentials related to user profile 160. Computing device 130 may also include a profile associated with a structure, such as structure profile 164. Structure profile 164 may be associated with and provide information about the hotel, motel, inn, lodge or other structure where computing device 130 may be located. For example, structure profile 164 may provide information related to a price and/or location of the hotel, motel, inn, lodge or other structure. Any number of profiles 160 may be associated with user 102. User profile 160 may be stored at a memory associated with content server 118. After logging in, user profile 160 may be accessed at content server 118 through network 114. Network 114 may be, for example, a wireless network, a local area network, the Internet, and/or another means of computer communication. In some examples, computing device 130 may be configured to execute an application 122. Application 122 may allow computing device 130 to interact with content server 118. Application 122 may be, for example, a program or set of instructions executable by processor 126 of computing device 130. In some examples, application 122 may be effective to keep track of which offers, advertisements, pages or other areas of application 122 that user 102 accesses most often. In some other examples, application 122 may include a messaging system which may allow user 102 to communicate with representatives of the virtual concierge service. In another example, user 102 may use application 122 to communicate with and/or make requests from a hotel in which computing device 130 may be located. In still another example, application 122 may be effective to adjust lighting, temperature, music and/or other characteristics of hotel room 112.

Content server 118 may include a user profile module 106 and/or an advertising module 108. User profile module 106 may be configured to provide user 102 access to user profile 160 at content server 118. User profile module 106 may be configured to collect information about user 102 based upon user choices and/or other user input. In an example, profile module 106 may collect information about past selections of goods and/or services. In some cases, the past selection of goods and/or services may have been received at a different location from hotel room 112. User profile module 106 may associate the information with user profile 160 of user 102. For example, user 102 may use computing device 130 to regularly order pepperoni pizza through hotel room service. User profile module 106 may update data and/or metadata in user profile 160 to indicate that user 102 enjoys pepperoni pizza. Additionally, user profile module 106 may request input from user 102. For example, user profile module 106 may request information about age, gender, preferences, likes, dislikes, etc. of user 102. User profile module 106 may update user profile 160 of user 102 based on responses and/or other input from user 102.

User 102 may select one or more goods and/or services displayed by computing device 130. In various examples, the goods and/or services may be provided by an entity that is different from the entity that owns hotel room 112. In some cases, goods and/or services selected by user 102 on computing device 130 may be provided outside hotel room 112. In some other examples, goods and services may be purchased over network 114 and may be delivered to hotel room 112 while user 102 is staying in hotel room 112.

User profile 160 may be updated based on the selections made by user 102. User profile 160 may include information about user 102, such as age information, career information, and/or demographic information. In some other examples, user profile 160 may include travel or purchase behavior information related to user 102. Additionally, user 102 may have multiple profiles and/or situational profile modifiers. For example, user 102 may have a first user profile 160 when traveling alone and a second user profile 162 when traveling with family. In the example, user profile 162 may include information about activities enjoyed by user 102 while traveling with family while user profile 160 may include information about activities enjoyed by user 102 when traveling alone. Additionally, each of user profiles 160, 162 may have various situational modifiers that may be selected by user 102. For example, “Alone,” “With husband,” and/or “With children,” for example. Such situational modifiers may affect recommendations and/or advertisements that may be provided by system 100.

User profile module 106 may be configured in communication with advertising module 108. Advertising module 108 may be hardware and/or some combination of hardware and instructions executable on the hardware configured to tailor advertisements to the user based on information collected by user profile module 106. Advertising module 108 may receive advertisements and/or other content through network 114. In some examples, advertising module 108 may request advertisements from an advertisement server 116 through network 114, based on information from user profile 160, user profile 162, and/or another profile.

In some other examples, advertisement server 116 and/or advertising module 108 may push advertisements or other content to computing device 130. For example, images related to goods and/or services may be pushed to and displayed by computing device 130. Pushed advertisements and content may be selected based on information collected about user 102. Advertisers may pay to have advertisements pushed from advertisement server 116 and/or content server 118 to computing device 130. In some examples, advertisements for computing device 130 may be identified based on user profiles 160, 162, and/or structure profile 164. Advertisements may be purchased based on different time slots throughout the day. For example, data collected at content server 118 may indicate that most users are active on system 100 from 7:00 PM-8:00 PM. Accordingly, advertising spots during 7:00 PM-8:00 PM may be sold for a higher price relative to times with less user traffic. Content server 118 may be configured to provide analytical performance data for advertisers, based on user interest. Content server 118 may provide a bidding system for advertisers to direct advertisements to particular users based on information included in user profiles, such as user profile 160 and/or user profile 162. In various other examples, advertisements may be based upon socio-economic factors, such as the price of hotel room 112 and/or the location of the hotel or other structure. For example, advertisements related to high end goods and services may be pushed to patrons staying in four star hotels. In other examples, advertisers may bid to show advertisements to patrons of hotels which may have room prices above or below a particular amount. In another example, advertisers may bid to show advertisements to patrons of hotels in a particular geographic area. Advertisement server 116 may select a bid associated with an advertisement to be pushed to user 102. The image of a good or service associated with the advertisement may be displayed by computing device 130.

User 102 may also use computing device 130 to access a reservation system 132. Computing device 130 may allow a user to make a reservation for a restaurant or event, for example. Computing device 130 may allow user 102 to interface with a reservation system 132. For example, user 102 may wish to purchase a concert ticket to a show at a local venue. Computing device 130 and/or application 122 may allow a user to access reservation system 132 of the venue. User 102 may use reservation system 132 to check for ticket availability or vacancy, check for times of events, make purchases and/or gather information such as pictures or reviews. In some examples, computing device 130 may charge the price of a purchase made through computing device 130 to the room bill for hotel room 112 through hotel management system 128. In an example, a hotel patron may purchase a meal at a restaurant advertised through computing device 130. The price of the meal may be added to an invoice for hotel room 112 through hotel management system 128. Hotel management system 128 may be, for example, a computing system designed to keep track of reservations, hotel patron accounts, hotel patron profiles, and/or other matters related to hotel management. For example, data representing a good and/or service selected by user 102 may be generated and added to a document or invoice related to hotel room 112 through hotel management system 128. The data may be effective to identify goods and/or services selected by user 102.

Content server 118 may also coordinate and associate multiple services on behalf of user 102. For example, if user 102 has made a reservation at a restaurant 140 through reservation system 132, computing device 130 may inquire whether the user would like for transportation to be arranged at a suitable time. In another example, if user 102 has purchased a lift ticket at a local ski resort, computing device 130 may offer ski equipment rental which may be available for the duration of the validity of the lift ticket. For example, user 102 may make a reservation at Charlie's Restaurant. Computing device 130 may determine (based on, e.g., GOOGLE MAPS, APPLE MAPS, etc.) the distance between Charlie's Restaurant and hotel room 112. Based on the distance and estimated traffic conditions, computing device 130 may recommend a taxi or car service reservation that will transport user 102 to Charlie's Restaurant at or before the reservation time. Computing device 130 may be configured to access a transportation server 120 (such as, for example, UBER) to make the taxi or car service reservation. In some examples, user 102 may be able to pay for services offered through system 100 by adding the costs to the price for hotel room 112 through hotel management system 128. In other examples, content server 118 may have pre-negotiated deals with local businesses, such as restaurants, transportation services, and/or entertainment providers, for example. Content server 118 may take geographic information, location information, climate information, and/or weather information into account when making recommendations, offering services, and/or providing targeted advertising to user 102.

In some other examples, computing device 130 may offer games, music, video, satellite radio, literature and/or other content to a user. Such content may be stored locally on memory 124 or may be downloaded or streamed through network 114. User profile module 106 may collect information related to content which user 102 consumes most frequently. User profile module 106 may update user profiles 160 and/or 162 with the collected information. Advertising module 108 may tailor advertisements for user 102 based upon information in user profile 160.

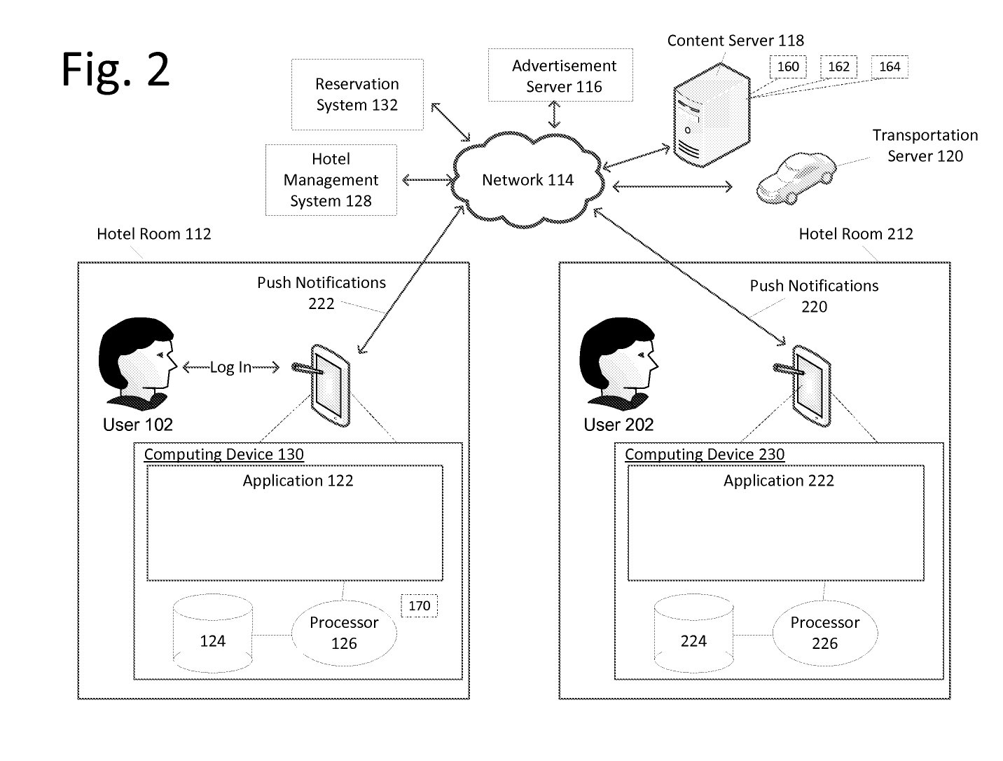

FIG. 2 illustrates another system that can be utilized to implement a virtual concierge service to multiple users, arranged in accordance with at least some embodiments described herein. FIG. 2 includes elements in system 100 of FIG. 1, with additional details. Those components in FIG. 2 that are labeled identically to components of FIG. 1 will not be described again for the purposes of clarity and brevity.

In some examples, user 102 may be a patron of a first hotel including hotel room 112. User 202 may be a patron of a second hotel including hotel room 212. The first and second hotels may be located in geographically distant locations, such as in different countries, or may be located close to one another, such as in the same city. Advertisements may be tailored to a particular user 102 and/or 202 based on past data collected about the user or may be generally sent to all users. For example, advertisement server 116 and/or content server 120 may send an advertisement to all users at a specified time. For example, content server 118 may identify that tickets for a concert starting in 30 minutes are available. Content server 118 may push advertisements to computing devices 130, 230 informing multiple users that the tickets are available. Users 102 and 202 may purchase the tickets through reservation system 132. In an example, computing devices 130 and/or 230 may directly access a reservation service of the concert venue.

Content server 118 and/or computing devices 130, 230 may provide a decision tree, game, and/or questionnaire which may pose questions to users 102, 202 and/or track user decisions to make predictions about a user's tastes, inclinations, likes, dislikes, etc. For example, a questionnaire or game may be provided to users 102, 202 through applications 122, 222. User responses to questions posed by the decision tree, game, or questionnaire may be tracked by content server 118 and integrated into a user profile, such as profile 160 and/or 162.

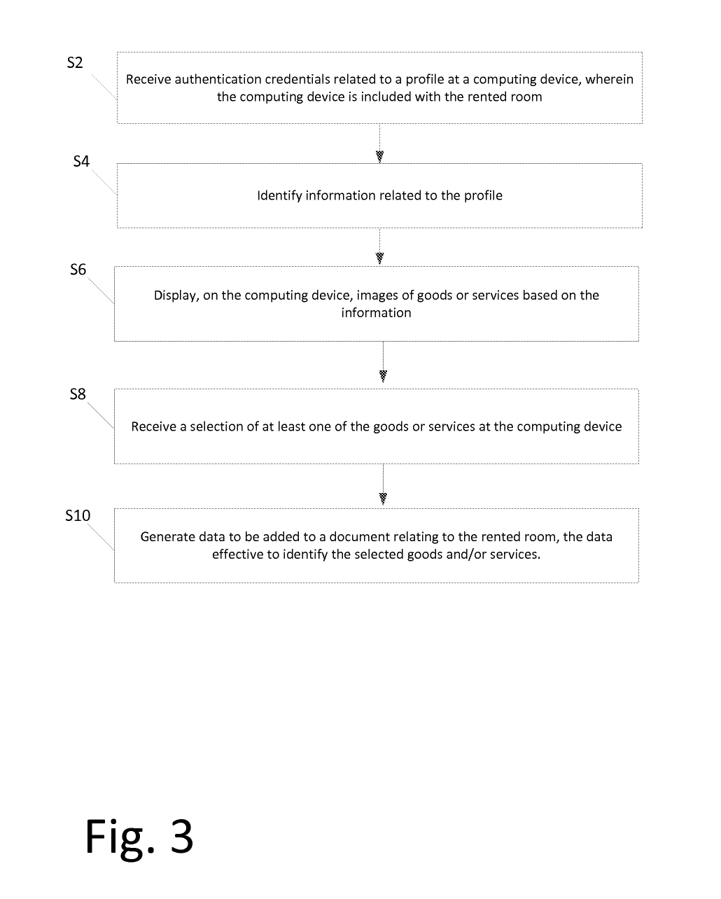

FIG. 3 depicts a flow diagram for an example process to generate data associated with a rented room, arranged in accordance with at least some embodiments described herein. In some examples, the process in FIG. 3 could be implemented using computing device 130 and/or content server 118 discussed above.

An example process may include one or more operations, actions, or functions as illustrated by one or more blocks S2, S4, S6, S8 and/or S10. Although illustrated as discrete blocks, various blocks may be divided into additional blocks, combined into fewer blocks, or eliminated, depending on the desired implementations.

Processing may begin at block S2, “Receive authentication credentials related to a profile at a computing device, wherein the computing device is included with the rented room.” At block S2, computing device 130 and/or content server 118 may receive authentication credentials related to a profile. The computing device may be included with a rented room. In some examples, the profile may be a first profile related to one or more lodgers associated with the rented room. A second profile may be received. The second profile may be related to a hotel, motel, inn, lodge, or other establishment related to the rented room. In some further examples, computing device 130 may be configured to display travel or purchase behavior related to the profile.

Processing may proceed from block S2 to block S4, “Identify information related to the profile.” At block S4, computing device 130 and/or content server 118 may identify information related to the profile. Identifying information related to the profile may include identifying information related to first and second profiles. The information may be at least partially based on user responses to a questionnaire or game.

Processing may proceed from block S4 to block S6, “Display, on the computing device, images of goods or services based on the information.” At block S6, images of goods and/or services may be displayed, based on the information. Displaying images of goods and/or services may further include receiving one or more bids from advertisers, wherein the one or more bids are based on the information. A particular bid from among the one or more bids may be selected by, for example, content server 118. The image of the good or service associated with the particular bid may be displayed by, for example, computing device 130. In some other examples, the rented room may be provided by a first entity and the goods and services may be provided by a second entity. In various other examples, the goods or services may be provided outside the rented room. In further examples, the goods or services may be first goods or services. The information may be at least partially based on other selections of second goods or services. The other selections may be received at a location other than the rented room. In some other examples, displaying the goods or services may be further based on weather or a geographical location.

Processing may proceed from block S6 to block S8, “Receive a selection of at least one of the goods or services at the computing device.” At block S8, a selection of at least one of the goods or services may be received at the computing device (e.g., computing device 130).

Processing may proceed from block S8 to block S10, “Generate data to be added to a document relating to the rented room, the data effective to identify the selected goods and/or services.” At block S10, data may be generated. The data may be added to a document relating to the rented room. The data may be effective to identify the selected goods and/or services.

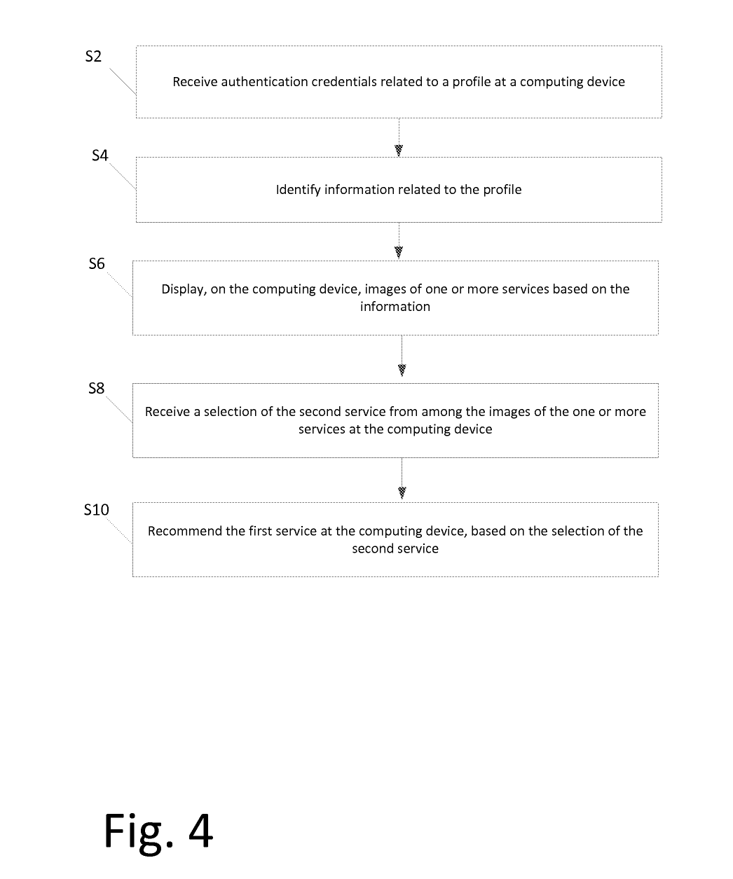

FIG. 4 depicts a flow diagram for an example process for recommending a service at a computing device, arranged in accordance with at least some embodiments described herein. In some examples, the process in FIG. 4 could be implemented using computing device 130 and/or content server 118 discussed above.

Processing may begin at block S2, “Receive authentication credentials related to a profile at a computing device.” At block S2, computing device 130 may be configured to receive authentication credentials related to a profile.

Processing may proceed from block S2 to block S4, “Identify information related to the profile.” At block S4, computing device 130 and/or content server 118 may identify information related to the profile.

Processing may proceed from block S4 to block S6, “Display, on the computing device, images of one or more services based on the information.” At block S6, computing device 130 may display one or more services based on the information.

Processing may proceed from block S6 to block S8, “Receive a selection of the second service from among the images of the one or more services at the computing device.” At block S8, computing device 130 may receive a selection of the second service from among the images of the one or more services. In some examples, the computing device may be located at a first location. The second service may be provided at a second location that is different from the first location. The first service may be a transportation service effective to provide transportation to the second location from the first location. In some examples, the transportation service may be effective to provide a vehicle to transport a user from the first location to the second location at a time at or before a starting time of the second service based on a distance between the first location and the second location. In some other examples, the transportation service may be effective to provide a vehicle to transport a user from the first location to the second location at a time at or before the starting time of the second service based on current or estimated traffic conditions.

Processing may proceed from block S8 to block S10, “Recommend the first service at the computing device, based on the selection of the second service.” At block S10, computing device 130 and/or content server 118 may recommend the first service based on the selection of the second service. In some examples, data may be generated to be added to a document relating to a rented room. The data may be associated with at least one of the first service and the second service.

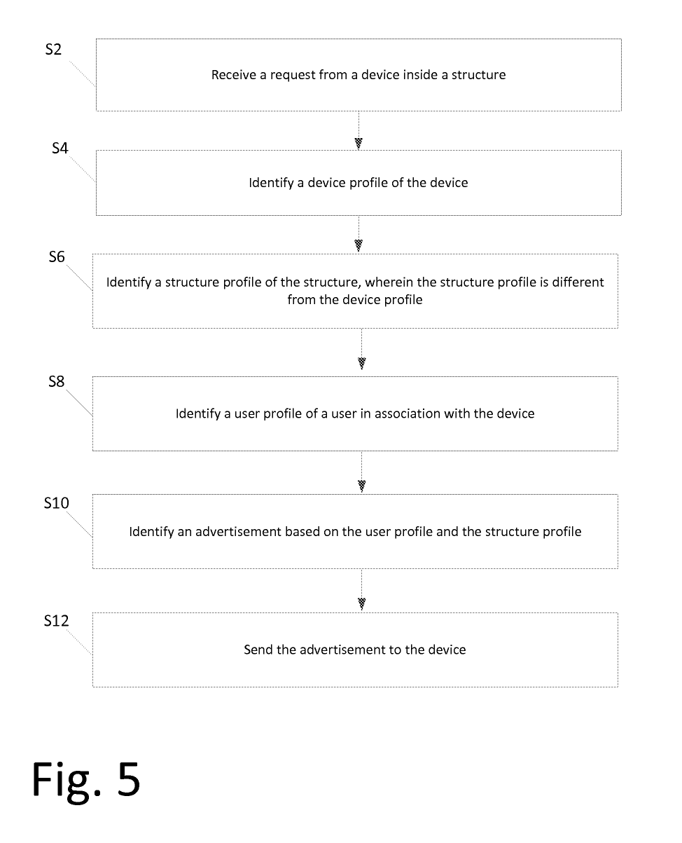

FIG. 5 depicts a flow diagram for an example process for implementing a virtual concierge service, arranged in accordance with at least some embodiments described herein. In some examples, the process in FIG. 5 could be implemented using computing device 130 and/or content server 118 discussed above.

Processing may begin at block S2, “Receive a request from a device inside a structure.” At block S2, a request may be received from a device inside a structure. In some examples, the device may be computing device 130 and the structure may be hotel room 112.

Processing may proceed from block S2 to block S4, “Identify a device profile of the device.” At block S4, a device profile of the device may be identified.

Processing may proceed from block S4 to block S6, “Identify a structure profile of the structure, wherein the structure profile is different from the device profile.” At block S6, a structure profile of the structure may be identified. For example, a structure profile may relate to a structure including hotel room 112. The structure profile may be different from the device profile.

Processing may proceed from block S6 to block S8, “Identify a user profile of a user in association with the device.” At block S8, a user profile of a user in association with the device may be identified.

Processing may proceed from block S8 to block S10, “Identify an advertisement based on the user profile and the structure profile.” At block S10, an advertisement may be identified based on the user profile and the structure profile.

Processing may proceed from block S10 to block S12, “Send the advertisement to the device.” At block S12, the advertisement may be sent to the device.

Among other potential benefits, a system in accordance with the disclosure may allow for personalized opportunities and recommendations to be provided to a hotel guest based on their previous transactions, behavior and/or interests. Additionally, the system may allow for multiple services to be coordinated, such as adaptive transportation services to and from user-selected destinations. Advertisers may also be able to purchase ad spots and direct personalized advertisements to hotel patrons based on socio-economic factors, user profiles, and/or external information, such as time of day, weather, and/or situational modifiers. The system may be configured to provide amenities to VIP (very important person) or other high profile guests, such as corporate executives, etc. Such amenities may be arranged in advance by an employer or may be generated by the system based on one or more profiles.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method to generate data associated with a rented room, the method comprising:
receiving authentication credentials related to a profile at a computing device, wherein the computing device is included with the rented room;
identifying information related to the profile;
displaying, on the computing device, images of goods or services based on the information;
receiving a selection of at least one of the goods or services at the computing device; and
generating data to be added to a document relating to the rented room, the data effective to identify the selected goods and/or services.

2. The method of claim 1, wherein the profile is a first profile related to one or more lodgers associated with the rented room, and the method further comprises:
receiving a second profile, wherein the second profile is related to a hotel, motel, inn, lodge, or other establishment related to the rented room, and wherein identifying information related to the profile includes identifying information related to the first and second profiles.

3. The method of claim 1, wherein displaying the images of goods or services further comprises:
receiving one or more bids from advertisers, wherein the (or an amount associated with the bids) one or more bids are based on the information;
selecting a particular bid from among the one or more bids; and
displaying the image of the good or service associated with the particular bid.

4. The method of claim 1, wherein the rented room is provided by a first entity, and wherein the goods or services are provided by a second entity, different from the first entity, and wherein the goods or services are provided outside the rented room.

5. The method of claim 1, wherein the goods or services are first goods or services, and wherein the information is at least partially based on other selections of second goods or services, wherein the other selections were received at a location other than the rented room.

6. The method of claim 1, wherein the information is at least partially based on user responses to a questionnaire or game.

7. The method of claim 1, wherein displaying the goods or services is further based on weather or a geographical location.

8. The method of claim 1, further comprising displaying, by the computing device, travel or purchase behavior related to the profile.

9. A method for recommending a first service at a computing device based on the selection of a second service, the method comprising:
receiving authentication credentials related to a profile at a computing device;
identifying information related to the profile;
displaying, on the computing device, images of one or more services based on the information;
receiving a selection of the second service from among the images of the one or more services at the computing device; and
recommending the first service at the computing device, based on the selection of the second service.

10. The method of claim 9, wherein:
the computing device is located at a first location;
the second service is provided at a second location that is different from the first location; and
the first service is a transportation service effective to provide transportation to the second location from the first location.

11. The method of claim 10, wherein the transportation service is effective to provide a vehicle to transport a user from the first location to the second location at a time at or before a starting time of the second service based on a distance between the first location and the second location.

12. The method of claim 10, wherein the transportation service is effective to provide a vehicle to transport a user from the first location to the second location at a time at or before a starting time of the second service based on current or estimated traffic conditions.

13. The method of claim 9, further comprising:
generating data to be added to a document relating to a rented room, wherein the data is associated with at least one of the first service and the second service, and wherein the computing device is located in the rented room.

14. A method for providing an advertisement to a device, the method comprising:
receiving a request from a device inside a structure;
identifying a device profile of the device;
identifying a structure profile of the structure, wherein the structure profile is different from the device profile;
identifying a user profile of a user in association with the device;
identifying an advertisement based on the user profile and the structure profile;
sending the advertisement to the device.

15. The method of claim 14, wherein the structure is a room in a hotel, motel, inn, or lodge, and wherein the structure profile relates to a price and location of the hotel, motel, inn, or lodge.

16. The method of claim 14, wherein the device is a first device, and further comprising pushing the advertisement to one or more second devices, wherein the first device is at a first location and at least one of the one or more second devices is at a second location, wherein the first location is different from the second location.

17. The method of claim 14, further comprising:
determining a time at which to send the advertisement; and
wherein sending the advertisement to the device is performed at the determined time.

18. The method of claim 14, further comprising:
receiving information related to an availability of a service; and
wherein the advertisement is based on the availability of the service.

19. The method of claim 14, wherein the user profile includes information about an age, career, and/or demographic of one or more people associated with the user profile.

20. The method of claim 14, wherein the advertisement is based on information about a price of a rented room in the structure and a location of the structure.
